(19) United States
(12) Patent Application Publication
(10) Pub. No.: US 2022/0101092 A1
(43) Pub. Date: Mar. 31, 2022

(54) NEURAL NETWORK DEVICE, NEURAL NETWORK SYSTEM, PROCESSING METHOD, AND RECORDING MEDIUM

(71) Applicants: NEC CORPORATION, Tokyo (JP); THE UNIVERSITY OF TOKYO, Tokyo (JP)

(72) Inventors: Yusuke SAKEMI, Tokyo (JP); Kai MORINO, Tokyo (JP); Kazuyuki AIHARA, Tokyo (JP)

(73) Assignees: NEC CORPORATION, Tokyo (JP); THE UNIVERSITY OF TOKYO, Tokyo (JP)

(21) Appl. No.: 17/440,068

(22) PCT Filed: Mar. 18, 2020
(86) PCT No.: PCT/JP2020/011909

§ 371 Date: Sep. 16, 2021

(30) Foreign Application Priority Data
Mar. 20, 2019 (JP) 2019-052880

(51) Int. Cl. G06N 3/04

(52) U.S. Cl. CPC G06N 3/049

(57) ABSTRACT

A neural network device includes: a neuron model unit configured as a non-leaky integrate-and-fire spiking neuron and a spiking neuron with which a postsynaptic current is represented using a step function, the neuron model unit being fired once at most in one process of a neural network to indicate an output of the neural model unit itself at firing timing; and a transfer processing unit that transfers information between the neuron model unit.

### TECHNICAL FIELD

The present invention relates to a neural network device, a neural network system, a processing method, and a recording medium.

### BACKGROUND ART

### (Feed-Forward Spiking Neural Networks)

As a form of neural network, there is a feed-forward spiking neural network (SNN). A spiking neural network is a network formed by connecting spiking neuron models (also referred to as spiking neurons or simply neurons).

A feed-forward type is one network configuration method, being a network in which information transmission in layer-to-layer coupling is one way. Each layer of a feed-forward spiking neural network is composed of one or more spiking neurons, with there being no connection between the spiking neurons in the same layer.

FIG. 14 is a diagram showing an example of a hierarchical structure of a feed-forward spiking neural network. FIG. 14 shows an example of a feed-forward four-layer spiking neural network. However, the number of layers of the feed-forward spiking neural network is not limited to four, and may be two or more.

As illustrated in FIG. 14, a feed-forward spiking neural network is configured in a hierarchical structure, receives the input of data, and outputs a calculation result. The calculation result output by the neural network is also called a predicted value or a prediction.

A first layer (layer 1011 in the example of FIG. 14) of the neural network is called an input layer, and the last layer (fourth layer (layer 1014) in the example of FIG. 14) is called an output layer. The layers between the input layer and the output layer (in the example of FIG. 14, the second layer (layer 1012) and the third layer (layer 1013)) are called hidden layers.

FIG. 15 is a diagram showing a configuration example of a feed-forward spiking neural network. FIG. 15 shows an example in which the four layers (layers 1011 to 1014) in FIG. 14 each have three spiking neurons (spiking neuron model) 1021. However, the number of spiking neurons included in the feed-forward spiking neural network is not limited to a specific number, and each layer may include one or more spiking neurons. Each layer may have the same number of spiking neurons, or the number of spiking neurons may differ with each layer.

The spiking neuron 1021 simulates signal integration and spike generation (firing) by the cell body of a biological neuron.

A transmission pathway 1022 simulates signal transmission by axons and synapses in biological neurons. The transmission path 1022 is arranged by connecting two spiking neurons 1021 between adjacent layers, and transmits a spike from the spiking neuron 1021 in the anterior layer to the spiking neuron 1021 in the posterior layer side.

In the example of FIG. 15, the transmission pathway 1022 transmits spikes from each of the spiking neurons 1021 in layer 1011 to each of the spiking neurons 1021 in layer 1012, from each of the spiking neurons 1021 in layer 1012 to each of the spiking neurons 1021 in layer 1013, and from each of the spiking neurons 1021 in layer 1013 to each of the spiking neurons 1021 in layer 1014.

The spiking neuron model is a model that has a membrane potential as an internal state, with the membrane potential evolving over time according to a differential equation. As a general spiking neuron model, a leaky integrate-and-fire neuron model is known, evolving over time according to a differential equation such as Eq. (1).

$$\begin{matrix}[ Eq . 1 ] & \\ \frac{d}{d t} {v}_{i}^{( n )} = - {α}_{l e a k} {v}_{i}^{( n )} + {I}_{i}^{( n )} , {I}_{i}^{( n )} = {\sum }_{j} {w}_{i j}^{( n )} κ ( t - {t}_{j}^{( n - 1 )} ) & ( 1 )\end{matrix}$$

Here, v⁽ⁿ⁾ᵢ indicates the membrane potential in the i-th spiking neuron model of the No. n layer. αₗₑₐₖ is a constant coefficient indicating the magnitude of the leak in the leaky integrate-and-fire model. I⁽ⁿ⁾ᵢ indicates the postsynaptic current in the i-th spiking neuron model of the No. n layer. w⁽ⁿ⁾ᵢⱼ is a coefficient indicating the strength of the connection from the j-th spiking neuron model of the No. n−1 layer to the i-th spiking neuron model of the No. n layer, and is called a weight.

t indicates time. t⁽ⁿ⁻¹⁾ⱼ indicates the firing timing (fire time) of the j-th neuron in the No. n−1 layer. κ is a function that indicates the effect of spikes transmitted from the previous layer on the postsynaptic current.

When the membrane potential exceeds the threshold value Vₜₕ, the spiking neuron model generates spikes (fires), after which the membrane potential returns to the reset value Vᵣₑₛₑₜ. In addition, the generated spikes are transmitted to the spiking neuron model of the connected posterior layer.

FIG. 16 is a diagram showing an example of the time evolution of the membrane potential of the spiking neuron. The horizontal axis of the graph of FIG. 16 indicates time, while the vertical axis indicates membrane potential. FIG. 16 shows an example of the time evolution of the membrane potential of the i-th spiking neuron in the No. n layer, with the membrane potential represented by v⁽ⁿ⁾ᵢ.

As described above, Vₜₕ indicates the threshold value of the membrane potential. Vᵣₑₛₑₜ indicates the reset value of the membrane potential. t⁽ⁿ⁻¹⁾₁ indicates the firing timing of the first neuron in the No. n−1 layer. t⁽ⁿ⁻¹⁾₂ indicates the firing timing of the second neuron in the No. n−1 layer. t⁽ⁿ⁻¹⁾₃ indicates the firing timing of the third neuron in the No. n−1 layer.

In both the first firing at time t⁽ⁿ⁻¹⁾₁ and the third firing at time t⁽ⁿ⁻¹⁾₃, the membrane potential v⁽ⁿ⁾ₜ does not reach the threshold value Vₜₕ. On the other hand, in the second firing at time t⁽ⁿ⁻¹⁾₂, the membrane potential v⁽ⁿ⁾ₜ reaches the threshold value Vₜₕ, and immediately thereafter, drops to the reset value Vᵣₑₛₑₜ.

Spiking neural networks are expected to consume less power than deep learning models when incorporated into hardware with CMOS (Complementary MOS) or the like. One of the reasons is that the human brain is a low power consumption computing medium equivalent to 20 watts (W), and spiking neural networks can mimic the cerebral activity of such low power consumption.

In order to create hardware with power consumption equivalent to that of the brain, it is necessary to develop an algorithm for spiking neural networks, following the calculation principle of the brain. For example, it is known that image recognition can be performed using a spiking neural network, and various supervised learning algorithms and unsupervised learning algorithms have been developed.

### (Information Transmission Method in Spiking Neural Networks)

In the algorithm of the spiking neural network, there are a number of methods for information transmission by spikes, and in particular, the frequency method and the time method are often used.

In the frequency method, information is transmitted based on how many times a specific neuron has fired in a fixed time interval. On the other hand, in the time method, information is transmitted at the timing of spikes.

FIG. 17 is a diagram showing an example of spikes in each of the frequency method and the time method. In the example of FIG. 17, in the frequency method, the information of “1”, “3”, and “5” is shown by the number of spikes corresponding to the information. On the other hand, in the time method, the number of spikes is one in any of the information of “1”, “3”, and “5”, and the information is shown by generating a spike at the timing according to the information. In the example of FIG. 17, the neuron generates a spike at a later timing as the number serving as the information increases.

As shown in FIG. 17, the time method can represent information with a smaller number of spikes than the frequency method. Non-Patent Document 1 reports that in tasks such as image recognition, the time method can be executed with a spike number of 1/10 or less of that of the frequency method.

Hardware power consumption increases as the number of spikes rises, so power consumption can be reduced by using a time-based algorithm.

### (Prediction by a Feed-Forward Spiking Neural Network)

It has been reported that various problems can be solved by using a feed-forward spiking neural network. For example, in the network configuration shown in FIG. 14, image data can be input to the input layer so that the spiking neural network can predict the answer. In the case of the time method, as a method of outputting the predicted value, for example, the predicted value can be indicated by the neuron that fired (generated a spike) earliest among the neurons in the output layer.

### (Learning of Feed-Forward Spiking Neural Networks)

A learning process is required for a spiking neural network to make correct predictions. For example, in the learning process of recognizing an image, image data and label data which is the answer thereof are used.

In the learning process, the spiking neural network receives the input of data and outputs predicted values. Then, the learning mechanism for causing the spiking neural network to perform learning calculates the prediction error, which is the difference between the predicted value output by the spiking neural network and the label data (correct answer). The learning mechanism causes the spiking neural network to perform learning by minimizing the loss function L defined from the prediction error by optimizing the weight of the network in the spiking neural network.

### (Minimization of the Loss Function)

For example, the learning mechanism can minimize the loss function L by updating the weight as in Eq. (2).

$$[ Eq . 2 ]$$

$$Δ {w}_{ij}^{( n )} = - η \frac{\partial L}{\partial {w}_{ij}^{( n )}} \qquad ( 2 )$$

Here, Δw⁽ⁿ⁾ᵢⱼ indicates an increase or decrease in the weight w⁽ⁿ⁾ᵢⱼ. If the value of Δw⁽ⁿ⁾ᵢⱼ is positive, the weight w⁽ⁿ⁾ᵢⱼ is increased. If the value of Δw⁽ⁿ⁾ᵢⱼ is negative, the weight w⁽ⁿ⁾ᵢⱼ is reduced.

η is a constant called the learning coefficient.

### (Stochastic Gradient Descent)

In the stochastic gradient descent method, the weight is updated once using some training data. When the weight update is repeated multiple times using all the training data, the repeating unit is called an epoch. Stochastic gradient descent generally performs tens to hundreds of epochs to converge learning. Further, updating the weight with one set of data (one input data and one label data) is called online learning, and updating with two or more sets of data is called mini-batch learning.

### (About the Output of the Prediction Result)

As mentioned above, it has been reported that various problems can be solved by using a feed-forward spiking neural network. For example, as described above, image data can be input to the input layer so that the network can predict the answer for that image.

FIG. 18 is a diagram showing an example of an output representation of the prediction result of the spiking neural network.

For example, in the task of recognizing an image of three numbers from 0 to 2, as shown in FIG. 18, three neurons form an output layer, each of which corresponds to a number from 0 to 2. The number indicated by the earliest firing neuron is the prediction indicated by the network. The operation of this network is time-based because the information is coded according to the firing timing of the neuron.

### (Nonlinear Functions and Hardware Implementation)

Dedicated hardware for spiking neural networks is generally called neuromorphic hardware. As for the mounting of this hardware, mounting by an analog circuit and mounting by a digital circuit are known.

It is generally required to reduce the power consumption and circuit area of hardware. However, on the other hand, if a complicated neuron model or a complicated learning rule is implemented, the power consumption and the circuit area will end up being increased.

### (Nonlinear Functions)

In a neuron model, a form including a non-linear function is often adopted because of its compatibility with biological neurons.

### (Data Movement)

The movement of memory data such as a weight makes a large contribution to the power consumption of neuromorphic hardware. Therefore, in the learning rule, power consumption can be reduced by using an algorithm with less data movement. In order to reduce the movement of data, one or both of reducing the number of movements and reducing the movement distance of data may be performed.

FIG. 19 is a diagram showing an example of data movement during prediction and learning. In FIG. 19, neurons are indicated by triangles and weights are indicated by circles. During prediction, data movement occurs as shown by the solid lines. On the other hand, at the time of learning, particularly at the time of updating the weight w1, the movement of data as shown by the broken lines occurs.

### (Non-Leaky Model)

Non-Patent Document 2 reported improving recognition accuracy by using a non-leaky integrate-and-fire model in which the constant αₗₑₐₖ of Eq. (1) was set to 0. In Non-Patent Document 2, the model represented by Eq. (3) is used as the non-leaky integrate-and-fire model.

$$[ Eq . 3 ]$$

$$\frac{d}{dt} {v}_{i}^{( n )} = {I}_{i}^{( n )} ( t ) , {I}_{i}^{( n )} ( t ) = {\sum }_{j} {w}_{ij}^{( n )} θ ( t - {t}_{j}^{( n - 1 )} ) exp ( - \frac{t - {t}_{j}^{( n - 1 )}}{τ} ) \qquad ( 3 )$$

Here, exp is a natural exponential function. τ indicates a constant.

### PRIOR ART DOCUMENTS

### Non-Patent Documents

[Non-Patent Document 1] T. Liu and 5 others, “MT-spike: A multilayer time-based spiking neuromorphic architecture with temporal error backpropagation”, Proceedings of the 36th International Conference on Computer-Aided Design, IEEE Press, 2017, p. 450-457.
[Non-Patent Document 2] H. Mostafa, “Supervised Learning Based on Temporal Coding in Spiking Neural Networks”, IEEE Transactions on Neural Networks and Learning Systems, vol. 29, 2018, p. 3227-3235.
[Non-Patent Document 3] S. M. Bohte and 2 others. “Error-backpropagation in temporally encoded networks of spiking neurons”, Neurocomputing, vol. 48, 2002, p. 17-37.

### SUMMARY OF THE INVENTION

### Problem to be Solved by the Invention

It is preferable to be able to simplify the model of the neural network.

For example, while in Non-Patent Document 2, the non-leaky integration model shown in the above Eq. (3) includes a non-linear function (exp (−x/τ)), it is preferable that the model be constructed without this non-linear function from the viewpoint of model simplification.

An object of the present invention is to provide a neural network device, a neural network system, a neural network processing method, and a recording medium capable of solving the above-mentioned problems.

### Means for Solving the Problem

According to a first example aspect of the present invention, a neural network device includes: a neuron model means configured as a non-leaky integrate-and-fire spiking neuron and a spiking neuron with which a postsynaptic current is represented using a step function, the neuron model means being fired once at most in one process of a neural network to indicate an output of the neural model means itself at firing timing; and a transfer processing means for transferring information between the neuron model means.

According to a second example aspect of the present invention, a processing method includes the steps of: performing an action of a spiking neuron, the spiking neuron being a non-leaky integrate-and-fire spiking neuron and a spiking neuron with which a postsynaptic current is represented using a step function, the spiking neuron being fired once at most in one process of a neural network to indicate output of the spiking neuron itself at firing timing; and performing information transfer between the spiking neuron.

According to a third example aspect of the present invention, a recording medium stores a program for causing an ASIC to execute the steps of: performing an action of a spiking neuron, the spiking neuron being a non-leaky integrate-and-fire spiking neuron and a spiking neuron with which a postsynaptic current is represented using a step function, the spiking neuron being fired once at most in one process of a neural network to indicate output of the spiking neuron itself at firing timing; and performing information transfer between the spiking neuron.

### Effect of the Invention

According to the present invention, a model of the neural network can be made relatively simple.

### BRIEF DESCRIPTION OF THE DRAWINGS

FIG. 1 is a diagram showing an example of a hierarchical structure of a neural network device according to an example embodiment.

FIG. 2 is a diagram showing a configuration example of a neural network device according to the example embodiment.

FIG. 3 is a diagram showing an example of a schematic configuration of a neural network system according to the example embodiment.

FIG. 4 is a diagram showing the relationship between the spike timing and the firing probability density according to the example embodiment.

FIG. 5 is a diagram showing a change in the firing probability density when the weight according to the example embodiment has changed.

FIG. 6 is a diagram showing a change in the firing probability density when the spike timing according to the example embodiment has changed.

FIG. 7 is a diagram showing an example of an update rule for the weight of a network according to the example embodiment.

FIG. 8 is a diagram showing an example of a simulation result of the neural network device according to the example embodiment.

FIG. 9 is a diagram showing how the membrane potential changes with a change in the weight according to the example embodiment.

FIG. 10 is a diagram showing a state in which the membrane potential changes with a change in the firing timing according to the example embodiment.

FIG. 11 is a diagram showing a configuration example of a neural network device according to the example embodiment according to an example embodiment.

FIG. 12 is a schematic block diagram showing a configuration example of dedicated hardware according to at least one example embodiment.

FIG. 13 is a schematic block diagram showing a configuration example of a computer according to at least one example embodiment.

FIG. 14 is a diagram showing an example of a hierarchical structure of a feed-forward spiking neural network.

FIG. 15 is a diagram showing a configuration example of a feed-forward spiking neural network.

FIG. 16 is a diagram showing an example of the time evolution of the membrane potential of a spiking neuron.

FIG. 17 is a diagram showing an example of spikes in each of the frequency method and the time method.

FIG. 18 is a diagram showing an example of the output representation of a prediction result of a spiking neural network.

FIG. 19 is a diagram showing an example of data movement during prediction and during learning.

### EXAMPLE EMBODIMENT

Hereinbelow, example embodiments of the present invention will be described, but the following example embodiments do not limit the invention claimed. Also, all combinations of features described in the example embodiments may not be essential to the solution of the invention.

### (Structure of Neural Network Device According to Example Embodiment)

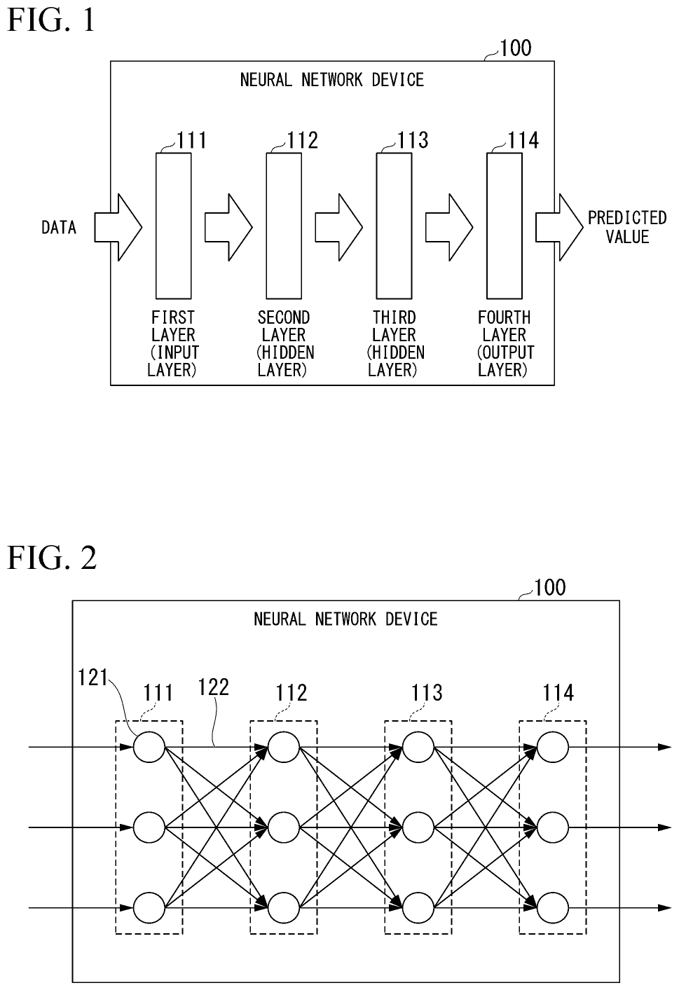

FIG. 1 is a diagram showing an example of a hierarchical structure of a neural network device according to the example embodiment.

In the example of FIG. 1, a neural network device 100 is configured as a four-layer feed-forward spiking neural network (SNN). However, the number of layers of the neural network device 100 is not limited to the four layers shown in FIG. 1, and may be two or more layers.

The neural network device 100 shown in FIG. 1 functions as a feed-forward spiking neural network, receives the input of data, and outputs a calculation result (predicted value or referred to as prediction).

Of each layer of the neural network device 100, the first layer (layer 111) corresponds to the input layer. The last layer (fourth layer, layer 114) corresponds to the output layer. The layers between the input layer and the output layer (second layer (layer 112) and third layer (layer 113)) correspond to hidden layers.

FIG. 2 is a diagram showing a configuration example of the neural network device 100. FIG. 2 shows an example in which the four layers (layers 111 to 114) in FIG. 1 each have three nodes (neuron model unit 121). However, the number of neuron model units 121 included in the neural network device 100 is not limited to a specific number, and each layer may include two or more neuron model units 121. Each layer may include the same number of neuron model units 121, or each layer may include a different number of neuron model units 121.

The neuron model unit 121 is configured as a spiking neuron (spiking neuron model), and simulates signal integration and spike generation (firing) by the cell body.

The transmission processing unit 122 simulates signal transmission by axons and synapses. The transmission processing unit 122 is arranged by connecting two neuron model units 121 between arbitrary layers, and transmits spikes from the neuron model unit 121 on the front layer side to the neuron model unit 121 on the rear layer side.

In the example of FIG. 2, the transmission processing unit 122 transmits a spike from each of the neuron model units 121 of layer 111 to each of the neuron model units 121 of layer 112, from each of the neuron model units 121 of layer 112 to each of the neuron model unit 121 of layer 113, and from each of the neuron model units 121 of layer 113 to each of the neuron model units 121 of layer 114.

### (Configuration of Neural Network System According to Example Embodiment)

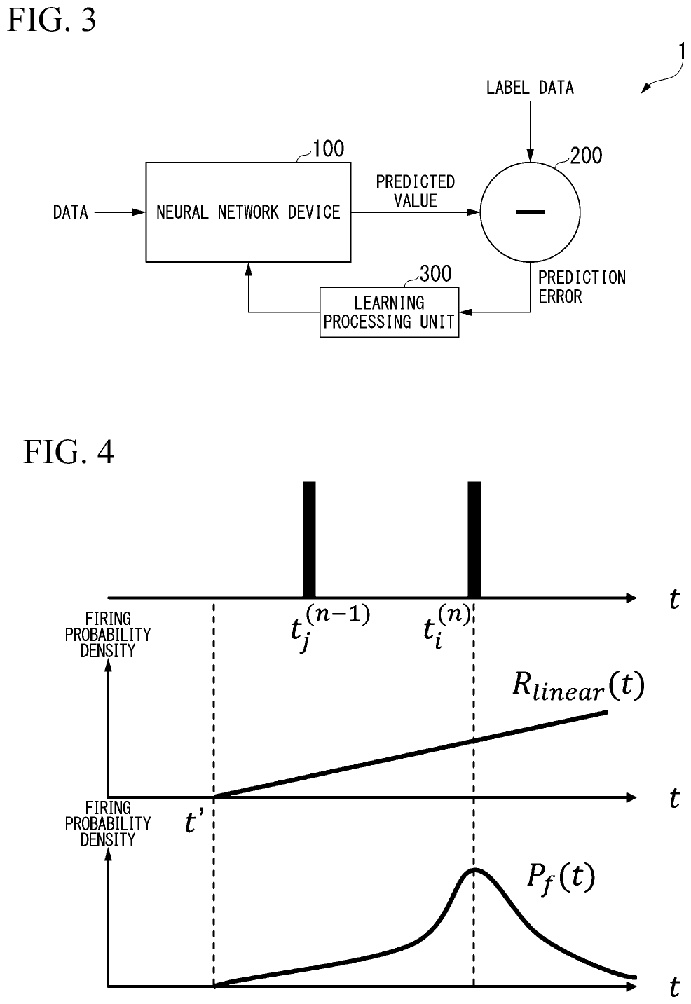

The neural network system according to the example embodiment has, for example, the configuration shown in FIG. 3 in order to execute the learning process.

FIG. 3 is a diagram showing an example of a schematic configuration of a neural network system according to the example embodiment. With the configuration shown in FIG. 3, the neural network system 1 includes a neural network device 100, a prediction error calculation unit 200, and a learning processing unit 300.

With such a configuration, the neural network device 100 receives data input and outputs a predicted value. The prediction error calculation unit 200 calculates a prediction error, which is the difference between the prediction value output by the neural network device 100 and the label data (correct answer), and outputs the prediction error to the learning processing unit 300. The learning processing unit 300 causes the neural network device 100 to perform learning by minimizing the loss function L defined from the prediction error by optimizing the network weight of the neural network device 100.

The neural network device 100 and the learning processing unit 300 may be configured as separate devices or may be configured as one device.

### (Model of Neuron According to Example Embodiment)

The spiking neuron model (neuron model unit 121) according to the example embodiment will be described. As the neuron model unit 121, a non-leaky spiking neuron model is used. This model is defined as Eq. (4).

$$[ Eq . 4 ]$$

$$\frac{d}{dt} {v}_{i}^{( m )} = {I}_{i}^{( m )} , {I}_{i}^{( m )} ( t ) = {\sum }_{j} {w}_{ij}^{( m )} θ ( t - {t}_{j}^{( m - 1 )} ) \qquad ( 4 )$$

Here, v^{(m)}ᵢ indicates the membrane potential in the i-th neuron model unit 121 of the m-th layer.

I^{(m)}ᵢ indicates the postsynaptic current in the i-th neuron model unit 121 of the m-th layer. As mentioned above, t indicates the time. I^{(m)}ᵢ(t) represents the postsynaptic current I^{(m)}ᵢ as a function of time t.

w^{(m)}ᵢⱼ is a coefficient (weight) indicating the strength of the connection from the j-th neuron model unit 121 of the m−1 layer to the i-th neuron model unit 121 of the m-th layer. t^{(m-1)}ⱼ indicates the firing timing of the j-th neuron model unit 121 of the m−1 layer. θ indicates a step function.

The step function θ is expressed as in Eq. (5).

$$[ Eq . 5 ]$$

$$θ ( t ) = \{ \begin{matrix}1 if t \geq 0 \\ 0 if t < 0\end{matrix} \qquad ( 5 )$$

The step function θ(t) is a function having a constant value of θ(t)=1 when t≥0 and a constant value of θ(t)=0 when t<0, and can be calculated with simple processing compared to a non-linear function such as exp(−x/τ).

As described above, the network of the neural network device 100 is configured as a feed-forward multi-layer network. Further, it is assumed that each of the neuron model units 121 fires at most once for one input to the neural network device 100.

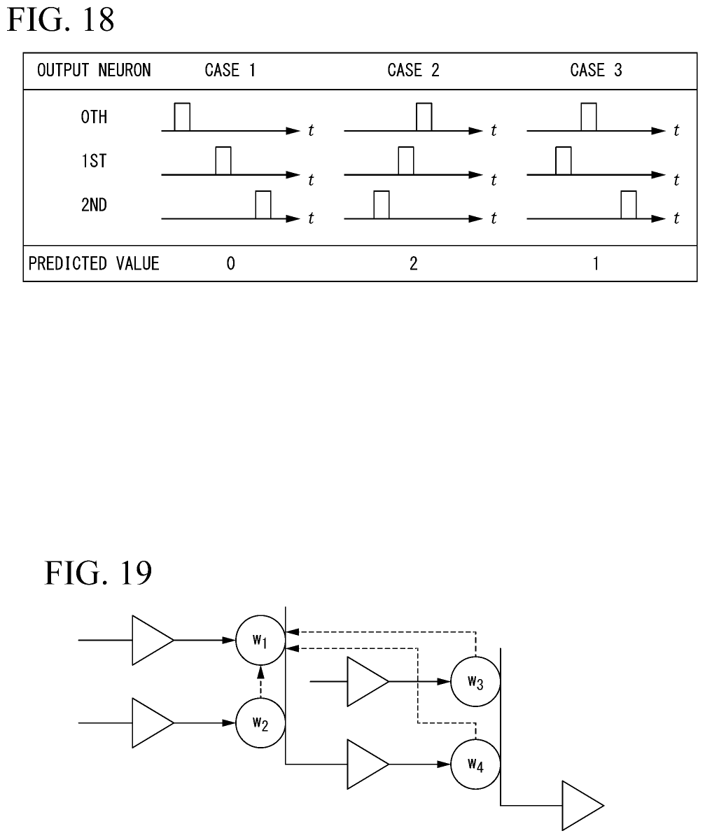

Further, it is assumed that the output of the neural network device 100 is indicated by the firing timing of the neuron model unit 121 of the output layer. For example, the output of the neural network device 100 may be shown using the representation method described with reference to FIG. 18.

### (Effect of Neuron Model According to Example Embodiment)

According to the neuron model unit 121, it is possible to achieve a relatively simple model represented by a weighted linear sum of step functions as shown in Eq. (4). For example, the model shown in Eq. (4) can be evaluated as simpler than the model shown in Eq. (3).

When the processing of the neuron model unit 121 is executed by software, the neuron model becomes a relatively simple model, so that the processing load is relatively light, the processing time is relatively short, and the power consumption is relatively low. When the processing of the neuron model unit 121 is executed by hardware, the neuron model becomes a relatively simple model, so that in addition to the processing load being relatively light, the processing time being relatively short, and the power consumption being relatively low, the circuit area of the hardware is relatively small.

With the neuron model unit 121, the recognition accuracy is high in that the model does not include leaks.

In addition, the neuron model unit 121, on the point of using the time method, consumes less power than the frequency method.

### (Output Layer Learning According to Example Embodiment (1))

Next, the learning algorithm in the neural network system 1 will be described.

### (Regarding SpikeProp)

The SpikeProp algorithm is known as a method for deriving the derivative ∂L/∂w⁽ⁿ⁾ᵢⱼ in the weight update rule of the above Eq. (2) (see Non-Patent Document 3). For example, the loss function L is defined by Eq. (6) using the firing timing of the neurons in the final layer.

$$[ Eq . 6 ]$$

$$L = {\sum }_{i} {L}_{i} , {L}_{i} = \frac{1}{2} {( {t}_{i}^{( N )} - {t}_{i}^{( t )} )}^{2} \qquad ( 6 )$$

Here, t^{(N)}, indicates the firing timing of the i-th neuron in the output layer. Note that “N” is used to denote the output layer as No. N layer.

t^{(N)}, indicates the firing timing of the i-th instruction signal (the firing timing of the i-th neuron in the output layer in the instruction signal). Moreover, here, the non-leaky neuron model shown in Eq. (3) is targeted.

The differential by weight of the loss function is shown by Eq. (7) using the chain rule.

$$[ Eq . 7 ]$$

$$\frac{\partial L}{\partial {w}_{ij}^{( n )}} = \frac{\partial {t}_{i}^{( n )}}{\partial {w}_{ij}^{( n )}} \frac{\partial L}{\partial {t}_{i}^{( n )}} = \frac{\partial {t}_{i}^{( n )}}{\partial {w}_{ij}^{( n )}} {δ}_{i}^{( n )} \qquad ( 7 )$$

The differential by weight of the loss function here is found by differentiating the loss function by weight.

Here, the propagation error is defined as in Eq. (8).

$$[ Eq . 8 ]$$

$${δ}_{j}^{( n )} = \frac{\partial L}{\partial {t}_{j}^{( n )}} = \{ \begin{matrix}( {t}_{j}^{( N )} - {t}_{j}^{( T )} ) , & for n = N \\ {\sum }_{i} \frac{\partial {t}_{i}^{( n + 1 )}}{\partial {t}_{j}^{( n )}} {δ}_{i}^{( n + 1 )} , & for n = 1 , 2 , … , N - 1\end{matrix} \qquad ( 8 )$$

Ultimately, in order to find the derivative, ∂t⁽ⁿ⁾ᵢ/∂w⁽ⁿ⁾ᵢⱼ and ∂t⁽ⁿ⁺¹⁾ᵢ/∂t⁽ⁿ⁾ⱼ are required to be calculated. Using the SpikeProp method ∂t⁽ⁿ⁾ᵢ/∂w⁽ⁿ⁾ᵢⱼ can be derived as in Eq. (9).

$$[ Eq . 9 ]$$

$$\begin{matrix}\frac{\partial {t}_{i}^{( n )}}{\partial {w}_{ij}^{( n )}} = \frac{\partial {v}_{i}^{( n )}}{\partial {w}_{ij}^{( n )}} \frac{\partial {t}_{i}^{( n )}}{\partial {v}_{i}^{( n )}} \\ = - ( {t}_{i}^{( n )} - {t}_{j}^{( n - 1 )} ) θ ( {t}_{i}^{( n )} - {t}_{j}^{( n - 1 )} ) {( \frac{\partial {v}_{i}^{( n )}}{\partial t} {\vert}_{t = {t}_{i}^{( n )}} )}^{- 1} \\ = \frac{- ( {t}_{i}^{( n )} - {t}_{j}^{( n - 1 )} ) θ ( {t}_{i}^{( n )} - {t}_{j}^{( n - 1 )} )}{{Σ}_{j} {w}_{ij}^{( n )} ( {t}_{i}^{( n )} - {t}_{j}^{( n - 1 )} )}\end{matrix} \qquad ( 9 )$$

Further, ∂t⁽ⁿ⁺¹⁾ᵢ/∂t⁽ⁿ⁾ⱼ can be derived as in Eq. (10).

$$[ Eq . 10 ]$$

$$\frac{\partial {t}_{i}^{( n + 1 )}}{\partial {t}_{j}^{( n )}} = \frac{\partial {v}_{i}^{( n + 1 )}}{\partial {t}_{j}^{( n )}} \frac{\partial {t}_{i}^{( n + 1 )}}{\partial {v}_{i}^{( n + 1 )}} = \frac{{w}_{ij}^{( n + 1 )} θ ( {t}_{i}^{( n + 1 )} - {t}_{j}^{( n )} )}{{Σ}_{j} {w}_{ij}^{( n + 1 )} θ ( {t}_{i}^{( n + 1 )} - {t}_{j}^{( n )} )} \qquad ( 10 )$$

As shown in Eqs. (9) and (10), in order to calculate ∂t⁽ⁿ⁾ᵢ/∂w⁽ⁿ⁾ᵢⱼ and ∂t⁽ⁿ⁺¹⁾ᵢ/∂t⁽ⁿ⁾ⱼ with the SpikeProp algorithm, it is necessary to calculate the sum of the weights in the same layer.

On the other hand, the neural network device 100 uses a learning rule simplified by approximating ∂t⁽ⁿ⁾ᵢ/∂w⁽ⁿ⁾ᵢⱼ and ∂t⁽ⁿ⁺¹⁾ᵢ/∂t⁽ⁿ⁾ⱼ. The derivation of this learning rule will be described.

First, it is assumed that the firing timing of the i-th neuron (neuron model unit 121) in the No. n layer is stochastically determined by the firing probability density Rⁿᵢ(t). As mentioned above, t indicates time. From the observed firing timing t⁽ⁿ⁾ᵢ of the No. n layer and the firing timing t⁽ⁿ⁻¹⁾ⱼ of the neuron (neuron model unit 121) in the previous layer, the functional form of the firing probability density R⁽ⁿ⁾ᵢ(t) is estimated.

In this model, each neuron (neuron model unit 121) fires only once or less, so it is the first firing timing that has information. Therefore, the time at which the distribution of the first firing timing (first firing time) of the neuron obtained from the estimated firing function (functional form of the firing probability density) reaches the maximum value is set as the firing timing t⁽ⁿ⁾ᵢ of the No. n layer.

By assuming the above model, the functional change δR⁽ⁿ⁾ᵢ(t) of the firing probability density when the weight w⁽ⁿ⁾ᵢⱼ has changed can be obtained. As shown in Eq. (11), the change δt⁽ⁿ⁾ᵢ of the firing timing can be obtained from this change of the firing probability density function.

[Eq. 11]

δwᵢⱼ⁽ⁿ⁾→δRᵢ⁽ⁿ⁾(t)→δtᵢ⁽ⁿ⁾ (11)

Eq. (11) shows the relationship that the change in the firing probability density R⁽ⁿ⁾ᵢ(t) is obtained according to the change in the weight w⁽ⁿ⁾ᵢⱼ, and the change in the firing timing t⁽ⁿ⁾ᵢ of the No. n layer can be obtained according to the change in the firing probability density R⁽ⁿ⁾ᵢ (t). From this relationship, the change in the firing timing t⁽ⁿ⁾ᵢ of the No. n layer can be obtained from the change in the weight w⁽ⁿ⁾ᵢⱼ.

From the relationship of Eq. (11), an approximation of partial differential can be obtained as in Eq. (12).

$$[ Eq . 12 ]$$

$$\frac{\partial {t}_{i}^{( n )}}{\partial {w}_{ij}^{( n )}} \approx \frac{\partial {t}_{i}^{( n )}}{\partial {w}_{ij}^{( n )}} \qquad ( 12 )$$

### (Example of Output Layer Learning (1) According to Example Embodiment)

The firing probability density R⁽ⁿ⁾ᵢ(t) can be approximated by the slope of the membrane potential (time differential) in the non-leaky spiking neuron model. This approximation is given by Eq. (13).

$$[ Eq . 13 ]$$

$${R}_{i}^{( n )} ( t ) \approx \frac{{dv}_{i}^{( n )}}{dt} = {I}_{i}^{( n )} ( t ) = {\sum }_{{j}^{′}} {w}_{{ij}^{′}}^{( n )} θ ( t - {t}_{{j}^{′}}^{( n - 1 )} ) \qquad ( 13 )$$

Further, this function is approximated to the piecewise linear function Rₗᵢₙₑₐᵣ(t) to obtain Eq. (14).

$$[ Eq . 14 ]$$

$${R}_{i}^{( n )} ( t ) \approx {\sum }_{{j}^{′}} {w}_{{ij}^{′}}^{( n )} θ ( t - {t}_{{j}^{′}}^{( n )} ) \approx α ( t - {t}^{′} ) θ ( t - {t}^{′} ) = {R}_{linear} ( t ) \qquad ( 14 )$$

Here, α and t′ are both constants, and as shown in FIG. 4, it is assumed that t′<t⁽ⁿ⁻¹⁾ⱼ is satisfied.

FIG. 4 is a diagram showing the relationship between spike timing and firing probability density.

The upper row of FIG. 4 shows the timing of t⁽ⁿ⁻¹⁾ⱼ and t⁽ⁿ⁾ᵢ. The middle row shows the estimated firing probability density Rₗᵢₙₑᵣ(t) of the i-th neuron of the nth layer. The lower row shows the probability distribution of the timing of the first firing calculated from the estimated firing probability density Rₗᵢₙₑᵣ(t). The horizontal axis of each of the upper, middle, and lower rows of FIG. 4 indicates time. The vertical axis of each of the middle and lower rows indicates firing probability density.

The probability of the first firing timing when the firing probability density is given by the piecewise linear function Rₗᵢₙₑₐᵣ(t) can be calculated as follows. That is, assuming that the probability of never firing by time t is x(t), this satisfies the differential equation of Eq. (15).

$$[ Eq . 15 ]$$

$$\frac{dx}{dt} = - {xR}_{linear} ( t ) = α x ( t - {t}^{′} ) θ ( t - {t}^{′} ) \qquad ( 15 )$$

Solving the differential equation of Eq. (15) gives Eq. (16).

$$[ Eq . 16 ]$$

$$x = {e}^{- \frac{1}{2} {α ( t - {t}^{′} )}^{2} θ ( t - {t}^{′} )} \qquad ( 16 )$$

Therefore, the first spike firing probability density P_{f}(t) can be obtained as in Eq. (17).

$$[ Eq . 17 ]$$

$${P}_{f} ( t ) = - \frac{dx}{dt} = α ( t - {t}^{′} ) θ ( t - {t}^{′} ) {e}^{- \frac{1}{2} {α ( t - {t}^{′} )}^{2} θ ( t - {t}^{′} )} \qquad ( 17 )$$

It can be seen that the first spike firing probability density P_{f}(t) is non-negative and satisfies the definition of probability as in Eq. (18).

$$[ Eq . 18 ]$$

$${\int }_{- ∞}^{∞} {P}_{f} ( t ) d t = - {\int }_{- ∞}^{∞} \frac{d x}{dt} d t = {[ x ]}_{- ∞}^{∞} = 1 - 0 = 1 \qquad ( 18 )$$

The time t* at which the first spike firing probability density P_{f}(t) takes the maximum value is shown as in Eq. (19) because the time differential of P_{f}(t) is 0 (∂P_{f}(t)/∂t=0).

$$[ Eq . 19 ]$$

$${t}^{*} = {t}^{′} + \frac{1}{α} \qquad ( 19 )$$

Eq. (20) is obtained by imposing a condition in which this time t* matches the output spike time.

$$[ Eq . 20 ]$$

$$α = \frac{1}{{t}_{i}^{( n )} - {t}^{′}} \qquad ( 20 )$$

Next, the change in the firing probability density Rⁿᵢ(t) of the neuron (neuron model unit 121) when the weight changes is shown by Eq. (21).

$$[ Eq . 21 ]$$

$$\frac{δ {R}_{i}^{( n )}}{δ {w}_{i j}^{( n )}} \approx \frac{δ ( {I}_{i}^{( n )} ( t ) )}{δ {w}_{i j}^{n}} = \frac{\partial {I}_{i}^{( n )}}{\partial {w}_{i j}^{n}} = θ ( t - {t}_{j}^{( n - 1 )} ) \qquad ( 21 )$$

The firing probability density is expressed by the piecewise linear function Rₗᵢₙₑₐᵣ(t), and the change δRᵢ(t) is expressed by Eq. (22).

[Eq. 22]

Rₗᵢₙₑₐᵣ(t)+δRᵢ(t)≈a(t−t′)θ(t−t′)+δwᵢⱼθ(t−tⱼⁿ⁻¹) (22)

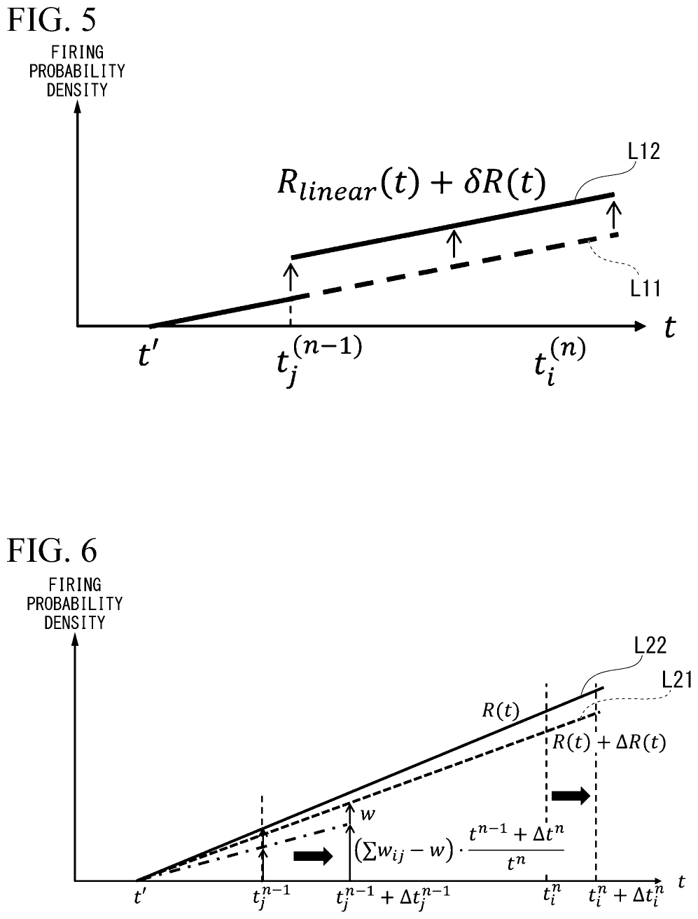

This change is shown in FIG. 5.

FIG. 5 is a diagram showing a change in the firing probability when the weight has changed. Specifically, FIG. 5 shows the change in the firing probability density Rₗᵢₙₑₐᵣ(t) when the weight W⁽ⁿ⁾ᵢⱼ has changed by δW⁽ⁿ⁾ᵢⱼ.

The horizontal axis of FIG. 5 indicates time, and the vertical axis indicates firing probability density. The line L11 shows the firing probability density before the weight W⁽ⁿ⁾ᵢⱼ changes, and the line L12 shows the firing probability density after the weight W⁽ⁿ⁾ᵢⱼ has changed.

The firing timing when this firing function is given is expressed as t⁽ⁿ⁾ᵢ+δt⁽ⁿ⁾ᵢ. The equation to be solved in order to obtain t⁽ⁿ⁾ᵢ+δt⁽ⁿ⁾ᵢ is expressed by Eq. (23).

$$[ Eq . 23 ]$$

$$\frac{d x}{d t} = α x ( ( t - {t}^{′} ) θ ( t - {t}^{′} ) + \frac{δ {w}_{ij}}{α} θ ( t - {t}_{j}^{n - 1} ) ) \qquad ( 23 )$$

Alternatively, the equation to be solved in order to obtain t⁽ⁿ⁾ᵢ+δt⁽ⁿ⁾ᵢ is expressed by Eq. (24).

$$[ Eq . 24 ]$$

$$\begin{matrix}\frac{d x}{d t} = \{ \begin{matrix}0 ( t \leq {t}^{′} ) \\ α x ( t - {t}^{′} ) ( {t}^{′} < t \leq {t}_{j}^{( n - 1 )} ) \\ α x ( t - ( {t}^{′} - \frac{δ {w}_{i j}}{α} ) ) ( {t}_{j}^{( n - 1 )} < t )\end{matrix} & ( 24 )\end{matrix}$$

The solution of Eq. (24) is as shown in Eq. (25), with the initial condition being x(0)=1.

$$[ Eq . 25 ]$$

$$\begin{matrix}x ( t ) = \{ \begin{matrix}1 ( t \leq {t}^{′} ) \\ {e}^{- \frac{α}{2} {( t - {t}^{′} )}^{2}} ( {t}^{′} < t \leq {t}_{j}^{( n - 1 )} ) \\ A {e}^{- \frac{α}{2} {( t - ( {t}^{′} - \frac{δ {w}_{i j}}{α} ) )}^{2}} ( {t}_{j}^{( n - 1 )} \leq t )\end{matrix} & ( 25 )\end{matrix}$$

A in Eq. (25) is shown as in Eq. (26).

$$[ Eq . 26 ]$$

$$A = \frac{{e}^{- \frac{α}{2} {( {t}^{n - 1} - {t}^{′} )}^{2}}}{{e}^{- \frac{a}{2} {( {t}^{n - 1} - ( {t}^{′} - \frac{Δ w}{α} ) )}^{2}}} \qquad ( 26 )$$

At this time, the time t* at which the first spike firing probability density P_{f}(t) takes the maximum value is as shown in Eq. (27).

$$[ Eq . 27 ]$$

$$\begin{matrix}{t}^{*} = \{ \begin{matrix}{t}_{i}^{( n )} for {t}_{i}^{( n )} \leq {t}_{i}^{( n - 1 )} \\ {t}_{i}^{( n )} - \frac{δ {w}_{i j}^{( n )}}{α} for {t}_{i}^{( n - 1 )} < {t}_{i}^{( n )}\end{matrix} & ( 27 )\end{matrix}$$

The time change of the output spike estimated when the weight has changed by δw⁽ⁿ⁾ᵢⱼ is expressed by Eq. (28).

$$[ Eq . 28 ]$$

$$δ {t}_{i}^{( n )} = - \frac{δ {w}_{i j}^{( n )}}{α} θ ( {t}_{i}^{( n )} - {t}_{j}^{( n - 1 )} ) \qquad ( 28 )$$

Eq. (29) is obtained as an approximate value of the partial differential.

$$[ Eq . 29 ]$$

$$\frac{\partial {t}^{( n )}}{\partial {w}_{i j}^{( n )}} \approx \frac{δ {t}_{i}^{( n )}}{δ {w}_{i j}^{( n )}} = - \frac{1}{α} θ ( {t}_{i}^{( n )} - {t}_{j}^{( n - 1 )} ) \qquad ( 29 )$$

Next, the approximation of ∂t⁽ⁿ⁾ᵢ/∂t⁽ⁿ⁻¹⁾ⱼ is performed.

Similar to the above, as shown in Eq. (30), the partial differential is obtained by deriving the relationship between δt⁽ⁿ⁻¹⁾ⱼ and t⁽ⁿ⁾ᵢ by passing through the change of the firing probability density R.

[Eq. 30]

δtⱼ⁽ⁿ⁻¹⁾→δR→tᵢ⁽ⁿ⁾ (30)

FIG. 6 is a diagram showing a change in the firing probability density when the spike timing changes.

Specifically, FIG. 6 shows how the firing probability density Rₗᵢₙₑₐᵣ(t) of the posterior layer neurons (neuron model unit 121) changes when the firing time t⁽ⁿ⁻¹⁾ⱼ of the neuron in the first stage layer (neuron model unit 121) has changed by δt⁽ⁿ⁻¹⁾ⱼ.

The horizontal axis of FIG. 6 indicates time, and the vertical axis indicates firing probability density. The line L21 shows the firing probability density Rₗᵢₙₑₐᵣ before the change, while the line L21 shows the firing probability density Rₗᵢₙₑₐᵣ(t)+δRₗᵢₙₑᵣ(t) after the change.

The piecewise linear function Rₗᵢₙₑₐᵣ(t), which linearly approximates the firing probability density, averages the spikes from all neurons in n−1 layer (neuron model unit 121) to the i-th neuron in the n layer (neuron model unit 121), and can be transformed as in Eq. (31).

$$[ Eq . 31 ]$$

$$\begin{matrix}{R}_{linear} = α ( t - {t}^{′} ) θ ( t - {t}^{′} ) \\ = α ( \frac{{w}_{i j}^{( n )} θ ( t - {t}_{j}^{( n - 1 )} )}{{\sum }_{( i , {j}^{′} )} {w}_{{ij}^{′}}^{( n )} θ ( t - {t}_{{j}^{′}}^{( n - 1 )} )} + \frac{{\sum }_{{j}^{′} \neq j} {w}_{{ij}^{′}}^{( n )} θ ( t - {t}_{{j}^{′}}^{( n - 1 )} )}{{\sum }_{( i , {j}^{′} )} {w}_{{ij}^{′}}^{( n )} θ ( t - {t}_{{j}^{′}}^{( n - 1 )} )} ) ( t - {t}^{′} ) θ ( t - {t}^{′} ) \\ = ( \frac{{w}_{i j}^{( n )} θ ( t - {t}_{j}^{( n - 1 )} )}{{t}_{j}^{( n - 1 )} - {t}^{′}} + \frac{{\sum }_{{j}^{′} \neq j} {w}_{{ij}^{′}}^{( n )} θ ( t - {t}_{{j}^{′}}^{( n - 1 )} )}{{t}_{j}^{( n - 1 )} - {t}^{′}} ) ( t - {t}^{′} ) θ ( t - {t}^{′} ) ,\end{matrix} \\ α = \frac{{\sum }_{( {i}^{′} , {j}^{′} )} {w}_{i j}^{( n )} θ ( t - {t}_{j}^{( n - 1 )} )}{{t}^{( n - 1 )} - {t}^{′}} \qquad [ Eq . 31 ]$$

The first term (w⁽ⁿ⁾ᵢⱼ θ(t−t⁽ⁿ⁻¹⁾ⱼ)(t⁽ⁿ⁻¹⁾ⱼ−t′)) in parentheses of Eq. (31) is due to the contribution of firing of the jth neuron of the No. n−1 layer. The second term (Σ_{j≠j}w⁽ⁿ⁾_{ij′}θ(t−t⁽ⁿ⁻¹⁾_{j′})(t⁽ⁿ⁻¹⁾ⱼ−t′)) is due to the contribution of firing of neurons other than the jth of the No. n−1 layer. The change δRₗᵢₙₑₐᵣ(t) of the firing probability density Rₗᵢₙₑₐᵣ(t) can be considered as the change δα of the slope α of Rₗᵢₙₑₐᵣ(t).

The inside of the parentheses of Eq. (31) shows the slope α, and the part that changes when the firing time t⁽ⁿ⁻¹⁾ⱼ of the neurons in the anterior layer has changed by δt⁽ⁿ⁻¹⁾ⱼ is only the first term due to the contribution of firing of the jth neuron in the No. n−1 layer. That is, the slope changes as shown in Eq. (32).

$$[ Eq . 32 ] \begin{matrix}\begin{matrix}α + δα = \frac{{\sum }_{{j}^{′} \neq j} {w}_{{ij}^{′}}^{( n )} θ ( t - {t}_{{j}^{′}}^{( n - 1 )} )}{{t}_{j}^{( n - 1 )} - {t}^{′}} + \frac{{w}_{i j}^{( n )} θ ( t - {t}_{j}^{( n - 1 )} )}{{t}_{j}^{( n - 1 )} - {t}^{′} + δ {t}_{j}^{( n - 1 )}} \\ = \frac{\begin{matrix}( {t}_{j}^{( n - 1 )} - {t}^{′} + δ {t}_{j}^{( n - 1 )} ) {\sum }_{{j}^{′} \neq j} {w}_{i {j}^{′}}^{( n )} θ ( t - {t}_{{j}^{′}}^{( n - 1 )} ) + \\ ( {t}_{j}^{( n - 1 )} - {t}^{′} ) {w}_{i j}^{( n )} θ ( t - {t}_{j}^{( n - 1 )} )\end{matrix}}{( {t}_{j}^{( n - 1 )} - {t}^{′} ) ( {t}_{j}^{( n - 1 )} - {t}^{′} + {δt}_{j}^{( n - 1 )} )} \\ = \frac{\begin{matrix}( {t}_{j}^{( n - 1 )} - {t}^{′} + δ {t}_{j}^{( n - 1 )} ) {\sum }_{{j}^{′}} {w}_{{ij}^{′}}^{( n )} θ ( t - {t}_{{j}^{′}}^{( n - 1 )} ) - \\ {δt}_{j}^{( n - 1 )} {w}_{i j}^{( n )} θ ( t - {t}_{j}^{( n - 1 )} )\end{matrix}}{( {t}_{j}^{( n - 1 )} - {t}^{′} ) ( {t}_{j}^{( n - 1 )} - {t}^{′} + δ {t}_{j}^{( n - 1 )} )} \\ = α - \frac{δ {t}_{j}^{( n - 1 )} {w}_{i j}^{( n )} θ ( t - {t}_{j}^{( n - 1 )} )}{( {t}_{j}^{( n - 1 )} - {t}^{′} ) ( {t}_{j}^{( n - 1 )} - {t}^{′} + δ {t}_{j}^{( n - 1 )} )} \\ = α - \frac{δ {t}_{j}^{( n - 1 )} {w}_{i j}^{( n )} θ ( t - {t}_{j}^{( n - 1 )} )}{{( {t}_{j}^{( n - 1 )} - {t}^{′} )}^{2}}\end{matrix} & ( 32 )\end{matrix}$$

Eq. (33) can be obtained from Eq. (19).

$$[ Eq . 33 ]$$

$$\frac{δ {t}_{i}^{( n )}}{δ α} \approx \frac{\partial {t}_{i}^{( n )}}{\partial α} \approx \frac{\partial }{\partial α} ( {t}^{′} + \frac{1}{α} ) = - \frac{1}{{α}^{2}} \qquad ( 33 )$$

As a result, the partial differential ∂t⁽ⁿ⁾ᵢ/∂t⁽ⁿ⁻¹⁾ⱼ can be approximated as in Eq. (34).

$$[ Eq . 34 ]$$

$$\begin{matrix}\frac{\partial {t}_{i}^{( n )}}{\partial {t}_{j}^{( n - 1 )}} \approx \frac{δ {t}_{i}^{( n )}}{δ {t}_{j}^{( n - 1 )}} = \frac{δα }{δ {t}_{j}^{( n - 1 )} } \frac{δ {t}_{i}^{( n )}}{δα} \\ \approx - \frac{{w}_{i j}^{( n )} θ ( {t}_{i}^{( n )} - {t}_{j}^{( n - 1 )} )}{{( {t}_{j}^{( n - 1 )} - {t}^{′} )}^{2}} \cdot - \frac{1}{{α}^{2}} = \frac{{w}_{i j}^{( n )} θ ( {t}_{i}^{( n )} - {t}_{j}^{( n )} )}{{{α}^{2} ( {t}_{j}^{( n - 1 )} - {t}^{′} )}^{2}}\end{matrix} \qquad ( 34 )$$

Here, the constant τ is set as in Eq. (35).

[Eq. 35]

τ=(tⱼ⁽ⁿ⁻¹⁾−t′) (35)

Eq. (36) is obtained using τ.

$$\begin{matrix}[ Eq . 36 ] & \\ \frac{\partial {t}_{i}^{( n )}}{\partial {t}_{j}^{( n - 1 )}} \approx \frac{{w}_{ij}^{( n )}}{{α}^{2} {τ}^{2}} θ ( {t}_{i}^{( n )} - {t}_{j}^{( n - 1 )} ) & ( 36 )\end{matrix}$$

### (Specific Example of Learning Rule)

From the above, an approximate learning rule of the weight of any layer in the neural network device 100 can be derived. Below, as specific examples, a learning rule of the No. N layer and a learning rule of the No. N−1 layer will be described.

The learning rule of the output layer is as shown in Eq. (37).

$$\begin{matrix} [ Eq . 37 ] & \\ {Δ w}_{ij}^{( n )} = - {η}_{0}^{( n )} \frac{\partial {L}_{i}}{\partial {w}_{ij}^{( n )}} \approx \frac{{η}_{0}^{( n )}}{α} ( {t}_{i}^{( n )} - {t}_{i}^{( t )} ) θ ( {t}_{i}^{( n )} - {t}_{j}^{( n - 1 )} ) = {η}^{( n )} ( {t}_{i}^{( n )} - {t}_{i}^{( t )} ) θ ( {t}_{i}^{( n )} - {t}_{j}^{( n - 1 )} ) & ( 37 )\end{matrix}$$

Here, η⁽ⁿ⁾ is expressed as in Eq. (38).

$$\begin{matrix}[ Eq . 38 ] & \\ {η}^{( n )} = \frac{{η}_{0}^{( n )}}{α} & ( 38 )\end{matrix}$$

η⁽ⁿ⁾₀ indicates the learning rate. Here, the learning rate η⁽ⁿ⁾ is redefined by using the combination of the learning rate η⁽ⁿ⁾₀ and the slope α of the firing probability density as shown in Eq. (38). In Eq. (38), the slope α of the firing probability density is treated as a constant.

The learning processing unit 300 performs learning of the output layer by updating the weight w^{(N)}ᵢⱼ for the input to the neuron model unit 121 of the output layer based on Eq. (37). As described above, the weight w^{(N)}ᵢⱼ indicates the strength of the connection between the j-th neuron model unit 121 of the No. N−1 layer and the i-th neuron model unit 121 of the No. Nth layer. Being an output layer, it should be read as n=N in Eq. (37).

A specific example of the learning rule (weight update rule) of the hidden layer is as shown in Eq. (39).

$$\begin{matrix} [ Eq . 39 ] & \\ {Δ w}_{j}^{( n - 1 )} = - {η}_{0}^{( n - 1 )} \frac{\partial L}{\partial {w}_{jk}^{( n - 1 )}} = - {η}_{0}^{( n - 1 )} {\sum }_{i} ( {t}_{i}^{( n )} - {t}_{i}^{( t )} ) \frac{\partial {t}_{j}^{( n - 1 )}}{\partial {w}_{jk}^{( n - 2 )}} \frac{\partial {t}_{i}^{( n )}}{\partial {t}_{j}^{( n - 1 )}} = - {η}_{0}^{( n - 1 )} \frac{\partial {t}_{j}^{( n - 1 )}}{\partial {w}_{jk}^{( n - 2 )}} {\sum }_{i} ( {t}_{i}^{( n )} - {t}_{i}^{( t )} ) \frac{\partial {t}_{i}^{( n )}}{\partial {t}_{j}^{( n - 1 )}} = \frac{{η}_{0}^{( n - 1 )}}{α} θ ( {t}_{j}^{( n - 1 )} - {t}_{k}^{( n - 2 )} ) {\sum }_{i} ( {t}_{i}^{( n )} - {t}_{i}^{( t )} ) \frac{{w}_{ij}^{( n )}}{{α}^{2} {τ}^{2}} θ ( {t}_{i}^{( n )} - {t}_{j}^{( n - 1 )} ) = \frac{{η}_{0}^{( n - 1 )}}{{α}^{3} {τ}^{2}} θ ( {t}_{j}^{( n - 1 )} - {t}_{k}^{( n - 2 )} ) = {η}^{( n - 1 )} θ ( {t}_{j}^{( n - 1 )} - {t}_{k}^{( n - 2 )} ) {\sum }_{i} ( {t}_{i}^{( n )} - {t}_{i}^{( t )} ) {w}_{ij}^{( n )} θ ( {t}_{i}^{( n )} - {t}_{j}^{( n - 1 )} ) & ( 39 )\end{matrix}$$

Eq. (40) is used for η⁽ⁿ⁻¹⁾.

$$\begin{matrix}[ Eq . 40 ] & \\ {η}^{( n - 1 )} = \frac{{η}_{0}^{( n - 1 )}}{{α}^{3} {τ}^{2}} & ( 40 )\end{matrix}$$

The learning processing unit 300 performs learning of the hidden layer by updating the weight w⁽ⁿ⁾ᵢⱼ with respect to the input of the nth layer (here, the hidden layer) to the neuron model unit 121 based on the Eq. (39). To do. As described above, the weight w⁽ⁿ⁾ᵢⱼ indicates the strength of the connection between the j-th neuron model portion 121 of the n-lth layer and the i-th neuron model portion 121 of the nth layer.

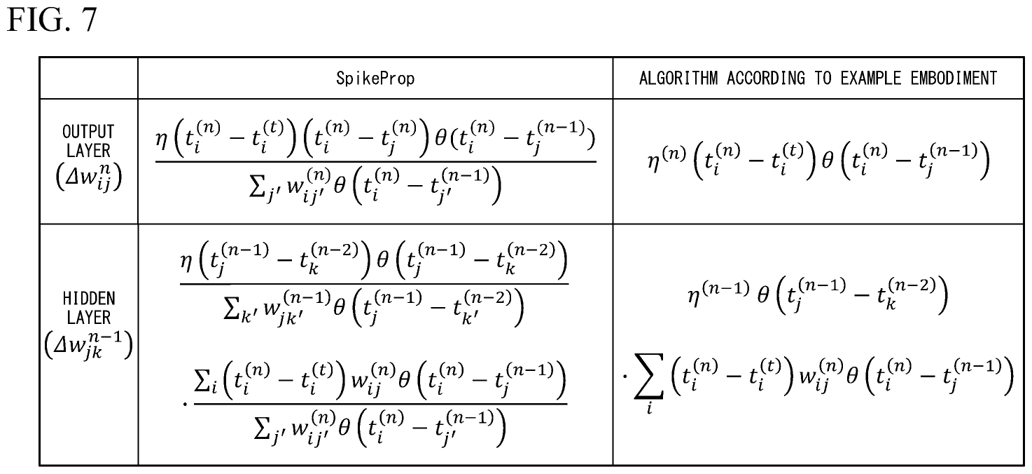

FIG. 7 is a diagram showing an example of a network weight update rule. FIG. 7 shows the update rule according to the example embodiment in a tabular form for each of the No. Nth layer and the No. N-lth layer in comparison with the example in the case of SpikeProp.

In the example of FIG. 7, for both the output layer and the hidden layer, the algorithm according to the example embodiment is shown by a simpler formula than in the case of SpikeProp. In this respect, by using the algorithm according to the example embodiment, the network weight update process (that is, the neural network learning process) can be made relatively simpler than in the case of SpikeProp.

When the algorithm according to the example embodiment is executed by software, the network weight update process is relatively simple, so that the processing load is relatively light, the processing time is relatively short, and the power consumption is relatively low. When the algorithm according to the example embodiment is executed by hardware, the network weight update process is relatively simple, so that in addition to the processing load being relatively light, the processing time being relatively short, and the power consumption being relatively small, the circuit area of the hardware is relatively small.

### (Simulation Example)

A simulation example of the neural network device 100 according to the example embodiment is shown. The MNIST data set, which is a handwritten character data set, was learned using the model according to the example embodiment (see Eq. (4)) and the learning algorithm according to the example embodiment (see FIG. 7). In the MNIST dataset, 60,000 each of a 784-dimensional vector, which is 28×28 pixel image, and a correct scalar value are provided for training, and 10,000 of similar 784-dimensional vector are given for testing.

In the simulation, the weight of the neural network is updated using the training data, and the performance is evaluated using the test data. The weight is not updated using the test data.

The network used in the simulation has three layers, the first layer being constituted of 169 input spiking neurons, and the second and third layers being constituted with 500 and 10 spiking neurons, respectively, (refer to Eq. (4)).

The input spiking neuron preprocesses the 28×28 pixel image data of the input data by convolution and reduces it to 169 pixels of 13×13. This reduces the amount of data and enables efficient simulation.

Online learning was conducted to update the weight for each image.

In addition, a simulation using the SpikeProp algorithm shown in FIG. 7 was also performed to compare the performance.

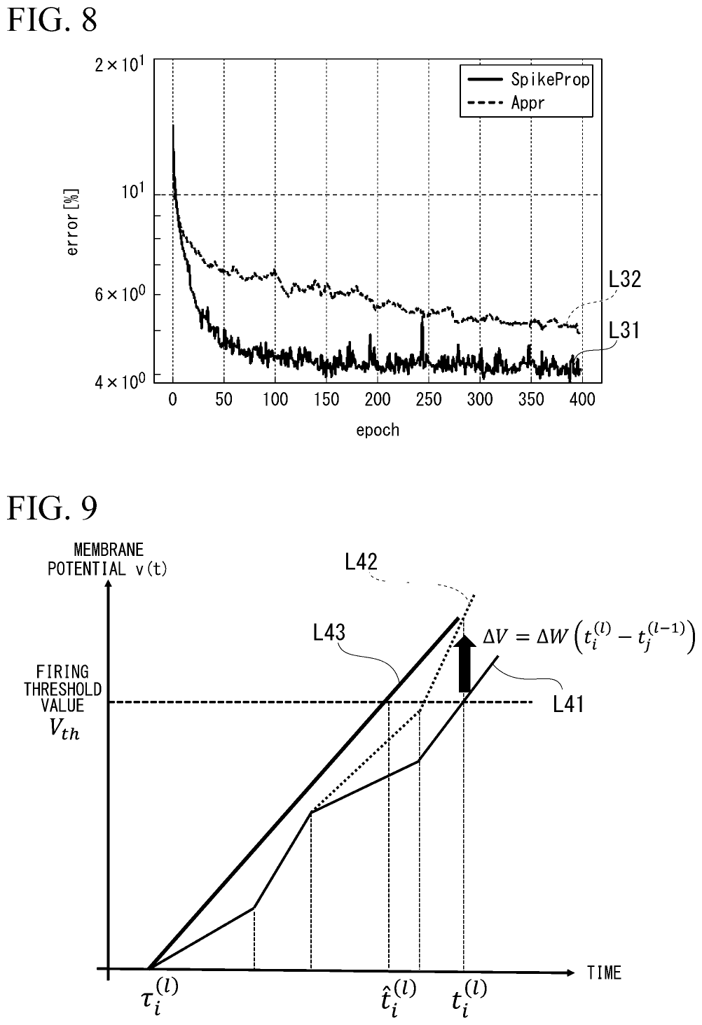

FIG. 8 is a diagram showing the simulation result. Line L31 shows the simulation result when the SpikeProp algorithm is used. Line L32 shows the result (simulation result of the neural network device 100) when the above-mentioned approximation algorithm is used. The horizontal axis of FIG. 8 shows the number of epochs, and the vertical axis shows the classification error rate at the time of testing.

With reference to FIG. 8, it can be seen that as the number of epochs increases, the classification error rate decreases in both the SpikeProp algorithm and the approximation algorithm.

The classification error rate was 3.8% in the SpikeProp algorithm and 4.9% in the approximation algorithm. It can thus be seen that the classification error rate is almost the same even when the approximation algorithm is used.

### (Learning of Output Layer According to Example Embodiment (2))

The other learning algorithms in the neural network system 1 will be described.

The differential by weight of the loss function is as shown in Eq. (41).

$$\begin{matrix}[ Eq . 41 ] & \\ \frac{\partial {L}_{i}}{\partial {w}_{ij}^{( l )}} = \frac{\partial L}{\partial {t}_{i}^{( l )}} \cdot \frac{\partial {t}_{i}^{( l )}}{\partial {w}_{ij}^{( l )}} , \\ \frac{\partial L}{\partial {t}_{i}^{( l )}} = {\sum }_{s} \frac{\partial L}{\partial {t}_{s}^{( l + 1 )}} \frac{\partial {t}_{s}^{( l + 1 )}}{\partial {t}_{i}^{( l )}} & ( 41 )\end{matrix}$$

The two terms on the right side of Eq. (41) (∂t^{(l)}ᵢ/∂w^{(l)}ᵢⱼ and ∂t^{(l+1)}ₛ/∂t^{(l)}ᵢ) are linearly approximated using a time evolution equation of the membrane potential, and a simple learning rule is derived.

As described above, w^{(l)}ᵢⱼ indicates the strength (weight) of the connection from the j-th neuron in the 1-1st layer to the i-th neuron in the 1-th layer. t^{(l)}ᵢ indicates the firing timing of the i-th neuron in the 1-th layer.

Derivation of the learning rule is possible by finding the partial differential “∂t^{(l)}ᵢ/∂w^{(l)}ᵢⱼ” and “∂t^{(l+1)}ₛ/∂t^{(l)}ᵢ” shown in Eq. (41). These can be calculated by the SpikeProp method as in Eq. (42).

$$\begin{matrix}[ Eq . 42 ] & \\ \frac{\partial {t}_{i}^{( l )}}{\partial {w}_{ij}^{( l )}} = - \frac{{t}_{i}^{( l )} - {t}_{j}^{( l - 1 )}}{{\sum }_{s} {w}_{is}^{( l )}} , \\ \frac{\partial {t}_{k}^{( l + 1 )}}{\partial {t}_{j}^{( l )}} = \frac{{w}_{Kj}^{( l + 1 )}}{{\sum }_{s} {w}_{ks}^{( l + 1 )}} & ( 42 )\end{matrix}$$

However, in both of the two equations shown in Eq. (42), in the sum of the denominators on the right side (Σₛ), the sum is taken only when the neurons in the presheaf that are connected to the weight of interest fire earlier than the neurons in the posterior layer. By approximating this denominator to the mean field, it is possible to greatly reduce the number of parameters required for learning.

First, ∂t^{(l)}ᵢ/∂w^{(l)}ᵢⱼ will be described.

FIG. 9 is a diagram showing how the membrane potential changes as the weight changes. FIG. 9 shows how the membrane potential v^{(l)}ᵢ at time t^{(l)}ᵢ changes from Vₜₕ to Vₜₕ+ΔV when the weight w^{(l)}ᵢⱼ changes to w^{(l)}ᵢⱼ+ΔW.

The horizontal axis of FIG. 9 indicates time, and the vertical axis indicates membrane potential. Line L41 shows an example of the time evolution of the membrane potential when the weight w^{(l)}ᵢⱼ does not change. Line L42 shows an example of the time evolution of the membrane potential when the weight w^{(l)}ᵢⱼ has changed. Line L43 shows a linear approximation of the time evolution of the membrane potential when the weight w^{(l)}ᵢⱼ has changed. According to line L43, the approximate solution of the firing time is the time tᵢ^{\hat{ }(l)} shown in FIG. 9.

The above-mentioned displacement ΔV of the membrane potential can be derived as shown in Eq. (43) as illustrated in FIG. 9.

[Eq. 43]

ΔV=ΔW(tᵢ^{(l)}−tⱼ^{(l-1)}) (43)

Then, by using the time τ^{(l)}ⱼ at which the firing was first transmitted to the j-th neuron in the l-layer and the threshold value Vₜₕ of the firing, it is possible to linearly approximate the time evolution of the membrane potential v*^{(l)}ᵢ(t) with respect to time. As a result of this approximation, the equation for the time evolution of the membrane potential can be derived as in Eq. (44).

$$\begin{matrix}[ Eq . 44 ] & \\ {v}_{i}^{* ( l )} ( t ) = \frac{{V}_{th} + Δ V}{{t}_{i}^{( l )} - {τ}_{i}^{( l )}} ( t - {τ}_{i}^{( l )} ) & ( 44 )\end{matrix}$$

The firing timing t*^{(l)}ᵢ under this approximation can be derived by solving Eq. (45).

[Eq. 45]

v*ᵢ^{(l)}(t**ᵢ^{(l)})=Vₜₕ (45)

The derived equation is as shown in Eq. (46).

$$\begin{matrix}[ Eq . 46 ] & \\ {t}_{i}^{* ( l )} = {τ}_{i}^{( l )} + \frac{{V}_{th}}{{V}_{th} + Δ V} ( {t}_{i}^{( l )} - {τ}_{i}^{( l )} ) & ( 46 )\end{matrix}$$

Thereby, it is possible to approximate ∂t^{(l)}ᵢ/∂w^{(l)}ᵢⱼ by taking the limit of ΔW→0 at (t*^{(l)}ᵢ−t^{(l)}ᵢ)/ΔW. An approximate expression of partial differential can be derived as in Eq. (47).

$$\begin{matrix} [ Eq . 47 ] & \\ \frac{{t}_{i}^{* ( l )} - {t}_{i}^{( l )}}{Δ W} = \frac{1}{Δ W} ( \frac{{V}_{th} - ( {V}_{th} + Δ V )}{{V}_{th} + Δ V} {t}_{i}^{( l )} + \frac{{V}_{th} + Δ V - {V}_{th}}{{V}_{th} + Δ V} {τ}_{i}^{( l )} ) = \frac{1}{Δ W} ( \frac{- Δ V}{{V}_{th} + Δ V} {t}_{i}^{( l )} + \frac{Δ V}{{V}_{th} + Δ V} {τ}_{i}^{( l )} ) = \frac{Δ W ( {t}_{i}^{( l )} - {t}_{j}^{( l - 1 )} )}{Δ W} ( \frac{- 1}{{V}_{th} + Δ V} {t}_{i}^{( l )} + \frac{1}{{V}_{th} + Δ V} {τ}_{i}^{( l )} ) = ( {t}_{i}^{( l )} - {t}_{j}^{( l - 1 )} ) ( \frac{- 1}{{V}_{th} + Δ V} {t}_{i}^{( l )} + \frac{1}{{V}_{th} + Δ V} {τ}_{i}^{( l )} ) \to - ( {t}_{i}^{( l )} - {t}_{j}^{( l - 1 )} ) ( \frac{{t}_{i}^{( l )} - {τ}_{i}^{( l )}}{{V}_{th}} ) & ( 47 )\end{matrix}$$

Next, an approximate expression of ∂t^{(l+1)}ⱼ/∂t^{(l)}ₖ is derived.

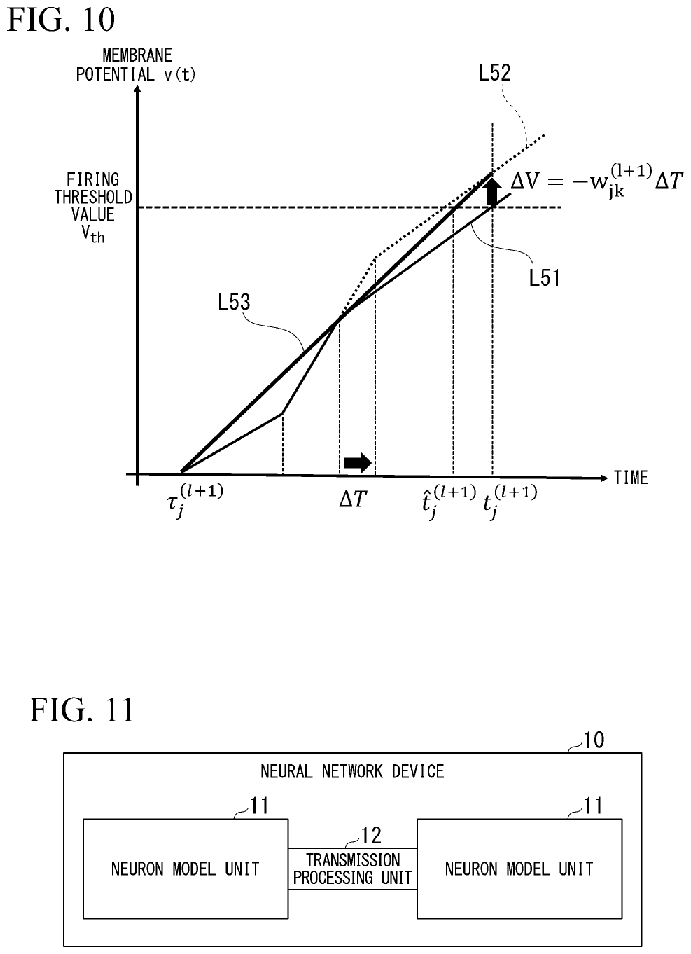

FIG. 10 is a diagram showing how the membrane potential changes as the firing timing changes. FIG. 10 shows how the membrane potential v^{(l+1)}ⱼ at time t^{(l+1)}ⱼ changes from Vₜₕ to Vₜₕ+ΔV when the firing timing changes from t^{(l)}ₖ to t^{(l)}ₖ+ΔT.

The horizontal axis of FIG. 10 indicates time, and the vertical axis indicates membrane potential. Line L51 shows an example of the time evolution of the membrane potential. Line L52 represents the time evolution of the membrane potential after the change. Line L53 shows an example of an approximation of the time evolution of the membrane potential. According to line L53, the approximate solution of the firing time is the time tᵢ^{\hat{ }(l+1)} shown in FIG. 10.

As shown in FIG. 10, the displacement ΔV of the membrane potential can be derived as −w^{(l+1)}ⱼₖΔT. Then, as before, by using the time τ^{(l+1)}ⱼ at which the firing was first transmitted to the j-th neuron in the l+1 layer and the firing threshold value Vₜₕ, it is possible to linearly approximate the time evolution of the membrane potential v*^{(l+1)}ⱼ(t) with respect to time. This mean approximation equation can be derived as in Eq. (48).

$$\begin{matrix}[ Eq . 48 ] & \\ {v}_{j}^{* ( l + 1 )} ( t ) = \frac{{V}_{th} + Δ V}{{t}_{j}^{( l + 1 )} - {τ}_{j}^{( l + 1 )}} ( t - {τ}_{j}^{( l + 1 )} ) & ( 48 )\end{matrix}$$

The firing timing t*^{(l+1)}ⱼ under this approximation can be derived by solving Eq. (49).

[Eq. 49]

v*ⱼ^{(l+1)}(t*ⱼ^{(l+1)})=Vₜₕ (49)

The firing timing t*^{(l+1)}ⱼ is derived as in Eq. (50).

$$\begin{matrix}[ Eq . 50 ] & \\ {t}_{j}^{* ( l + 1 )} = {τ}_{j}^{( l + 1 )} + \frac{{V}_{th}}{{V}_{th} + Δ V} ( {t}_{j}^{( l + 1 )} - {τ}_{j}^{( l + 1 )} ) & ( 50 )\end{matrix}$$

Thereby, it is possible to approximate ∂t^{(l+1)}ⱼ/∂t^{(l)}ₖ by taking the limit of ΔT→0 at (t*^{(l+1)}ⱼ−t^{(l+1)}ⱼ)/ΔT. An approximate expression of partial differential can be derived as in Eq. (51).

$$\begin{matrix} [ Eq . 51 ] & \\ \frac{{t}_{j}^{* ( l + 1 )} - {t}_{j}^{( l + 1 )}}{Δ T} = \frac{1}{Δ T} ( \frac{{V}_{th} - ( {V}_{th} + Δ V )}{{V}_{th} + Δ V} {t}_{j}^{( l + 1 )} + \frac{{V}_{th} + Δ V - {V}_{th}}{{V}_{th} + Δ V} {τ}_{j}^{( l + 1 )} ) = \frac{- {w}_{jk}^{( l + 1 )} Δ T}{Δ T} ( \frac{- 1}{{V}_{th} + Δ V} {t}_{j}^{( l + 1 )} + \frac{1}{{V}_{th} + Δ V} {τ}_{j}^{( l + 1 )} ) = {w}_{jk}^{( l + 1 )} ( \frac{{t}_{j}^{( l + 1 )} - {τ}_{j}^{( l + 1 )}}{{V}_{th} + Δ V} ) \to {w}_{jk}^{( l + 1 )} ( \frac{{t}_{j}^{( l + 1 )} - {τ}_{j}^{( l + 1 )}}{{V}_{th}} ) & ( 51 )\end{matrix}$$

Accordingly, ∂t^{(l)}ᵢ/∂w^{(l)}ᵢⱼ is approximated as in Eq. (52).

$$\begin{matrix}[ Eq . 52 ] & \\ \frac{\partial {t}_{i}^{( l )}}{\partial {w}_{ij}^{( l )}} \approx - ( {t}_{i}^{( l )} - {t}_{j}^{( l - 1 )} ) ( \frac{{t}_{i}^{( l )} - {τ}_{j}^{( l )}}{{V}_{th}} ) & ( 52 )\end{matrix}$$

∂t^{(l+1)}ⱼ/∂t^{(l)}ₖ is approximated as in Eq. (53).

$$\begin{matrix}[ Eq . 53 ] & \\ \frac{\partial {t}_{j}^{( l + 1 )}}{\partial {t}_{k}^{( l )}} \approx {w}_{jk}^{( l + 1 )} ( \frac{{t}_{j}^{( l + 1 )} - {τ}_{j}^{( l + 1 )}}{{V}_{th}} ) & ( 53 )\end{matrix}$$

By using the derived approximate equation of ∂t^{(l)}ᵢ/∂w^{(l)}ᵢⱼ (Eq. (52)) and the approximate equation of ∂t^{(l+1)}ⱼ/∂t^{(l)}ₖ (Eq. (53)), it is possible to derive a learning rule that greatly reduces the referencing of information of other neuron models.

The learning processing unit 300 applies, for example, the approximations shown in the Eqs. (52) and (53) when learning based on the above Eq. (41). The learning based on Eq. (41) can be applied to both the learning of the output layer and the learning of the hidden layer. The learning processing unit 300 may be made to perform learning of either the output layer or the hidden layer by learning by applying the approximations shown in Eq. (52) and (53) to Eq. (41), or may be made to perform learning of both.

As described above, the neuron model unit 121 is configured as a non-leaky integrate-and-fire spiking neuron and a spiking neuron with which a postsynaptic current is represented by using a step function, being fired once at the most in one process of a neural network to indicate the output of the neural model unit 121 itself at firing timing. The transmission processing unit 122 transmits information between the neuron model units 121.

One process of the neural network referred to here is a process in which the neural network outputs output data to a set of input data. For example, when a neural network performs pattern matching, one matching process corresponds to an example of one process of a neural network.

According to the neural network device 100, the neuron model unit 121 can be a relatively simple model using the step function under the conditions of leaks of the neuron model unit 121 being eliminated and all the neuron model units 121 firing only once or less.

When the processing of the neuron model unit 121 is executed by software, the neuron model becomes a relatively simple model, so that the processing load is relatively light, the processing time is relatively short, and the power consumption is relatively low. Further, when the processing of the neuron model unit 121 is executed by hardware, the neuron model becomes a relatively simple model, so that in addition to the processing load being relatively light, the processing time is relatively short, and the power consumption being relatively low, the circuit area of the hardware is relatively small.

According to the neuron model unit 121, on the point of being a model that does not include leaks, due to being a model in which neurons have no time constant, and not depending on the time constant of input data, the recognition accuracy is high.

In addition, the neuron model unit 121, on the point of using the time method, consumes less power than the frequency method.

Further, the learning processing unit 300 causes at least one of the output layer and the hidden layer of the neural network device 100 to be learned using a learning rule that applies at least either one of the approximation of the differential by weight of the firing time and the approximation of the differential by firing time of the firing time, obtained using a linear approximation of the time evolution of the membrane potential. Thereby, in the neural network system 1, learning of at least one of the output layer and the hidden layer can be executed by a relatively simple process using approximation.

When the learning algorithm by the learning processing unit 300 is executed by software, the learning processing is relatively simple, so that the processing load is relatively light, the processing time is relatively short, and the power consumption is relatively low. Further, when the learning algorithm by the learning processing unit 300 is executed by hardware, the learning processing becomes relatively simple, so that in addition to the processing load being relatively light, the processing time being relatively short, and the power consumption being relatively low, the circuit area of the hardware is relatively small.

Note that differential by weight of the firing time means differential of the firing time by the weight. Differential of firing time by firing time means that the firing time of a certain neuron model unit 121 is differentiated by the firing time of another neuron model unit 121.

Further, the learning processing unit 300 performs learning on the output layer of the neural network device by using a learning rule expressed using the slope of the firing probability density.

Thereby, in the neural network system 1, it is possible to find a change in the firing time based on the change in the firing probability density, and in this respect, the change in the firing time can be obtained relatively easily.

Next, a configuration of the example embodiment of the present invention will be described with reference to FIG. 11.

FIG. 11 is a diagram showing a configuration example of the neural network device according to the example embodiment. A neural network device 10 shown in FIG. 11 includes neuron model units 11 and a transmission processing unit 12.

In this configuration, each neuron model unit 11 is configured as a non-leaky integrate-and-fire spiking neuron and a spiking neuron with which a postsynaptic current is represented using a step function, being fired once at the most in one process of a neural network to indicate the output of the neural model unit 11 itself at firing timing. The transmission processing unit 12 transmits information between the neuron model units 11.

According to the neural network device 10, the neuron model unit 11 can be a relatively simple model using the step function under the condition of leaks of the neuron model unit 11 being eliminated and all the neuron model units 11 firing only once or less.

When the processing of the neuron model unit 11 is executed by software, the neuron model becomes a relatively simple model, so that the processing load is relatively light, the processing time is relatively short, and the power consumption is relatively low. Further, when the processing of the neuron model unit 11 is executed by hardware, the neuron model becomes a relatively simple model, so that in addition to the processing load being relatively light, the processing time being relatively short, and the power consumption being relatively low, the circuit area of the hardware is relatively small, the hardware circuit area is relatively small.

According to the neuron model unit 11, on the point of being a model that does not include leaks, due to being a model in which neurons have no time constant, and not depending on the time constant of input data, the recognition accuracy is high.

In addition, the neuron model unit 11, on the point of using the time method, consumes less power than the frequency method.

All or part of the neural network system 1 or all or part of the neural network device 10 may be implemented in dedicated hardware.

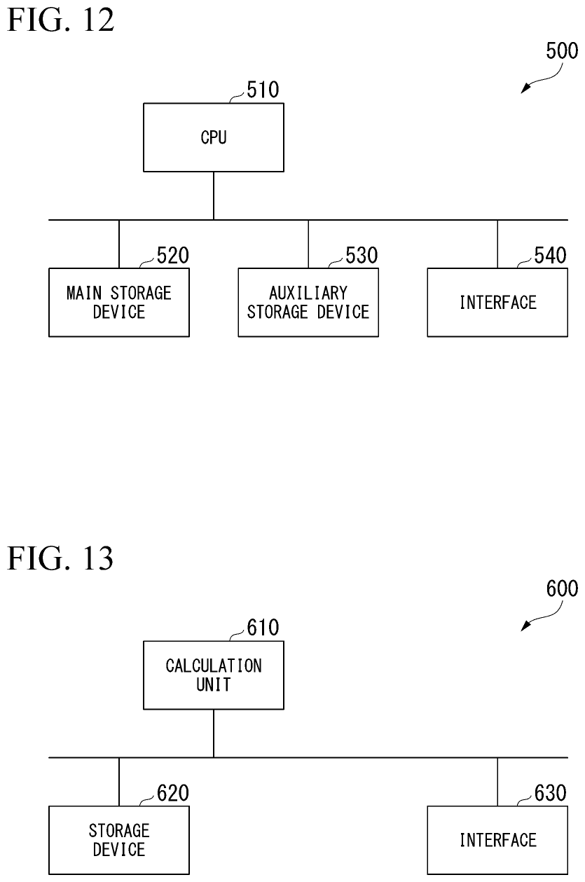

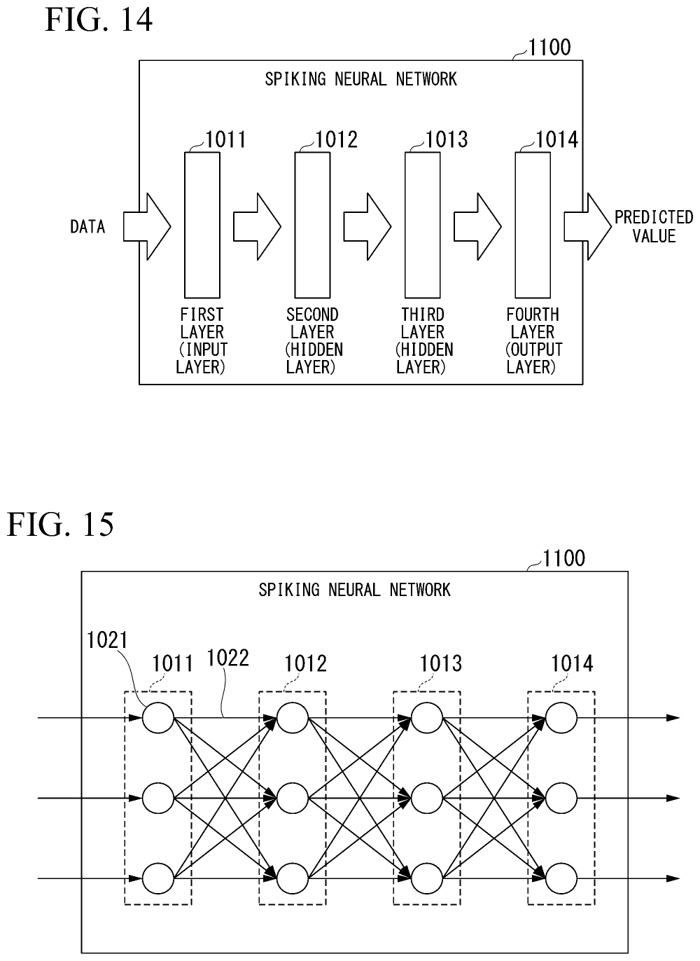

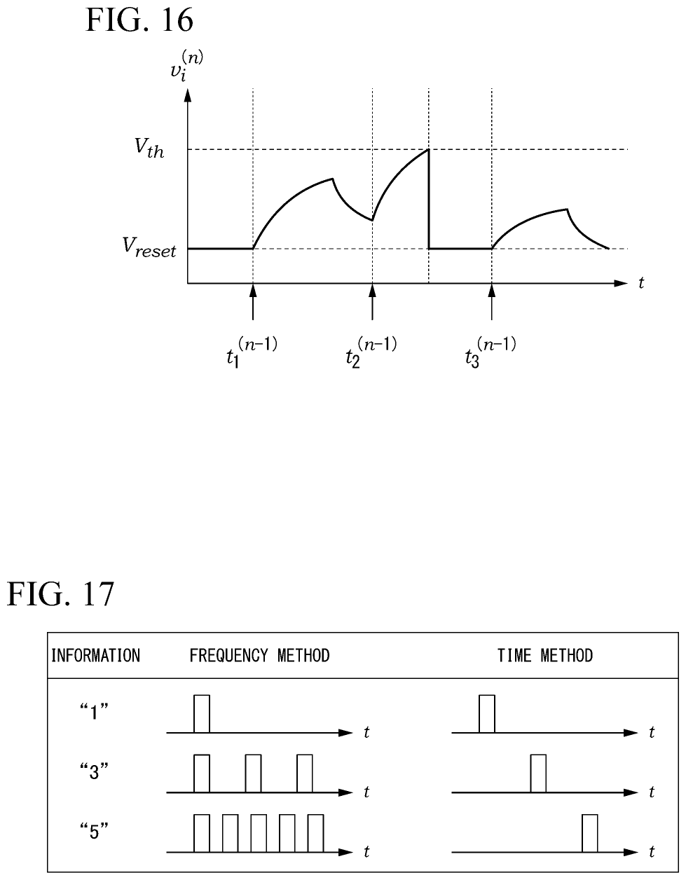

FIG. 12 is a schematic block diagram showing a configuration example of a dedicated hardware according to at least one example embodiment. In the configuration shown in FIG. 12, a dedicated hardware 500 includes a CPU 510, a main storage device 520, an auxiliary storage device 530, and an interface 540.

When the above-mentioned neural network system 1 is mounted on the dedicated hardware 500, the operation of each of the above-mentioned processing units (neural network device 100, neuron model unit 121, transmission processing unit 122, prediction error calculation unit 200, learning processing unit 300) is stored in the dedicated hardware 500 in the form of a program or a circuit.

All or part of the neural network system 1 or all or part of the neural network device 10 may be mounted on an ASIC (application specific integrated circuit).

FIG. 13 is a schematic block diagram showing a configuration example of a computer according to at least one example embodiment. With the configuration shown in FIG. 13, an ASIC 600 includes a calculation unit 610, a storage device 620, and an interface 630. Further, the calculation unit 610 and the storage device 620 may be unified (that is, they may be integrally configured).

An ASIC in which all or part of the neural network system 1 or all or part of the neural network device 10 is mounted executes the calculation by electronic circuits such as a CMOS. Each electronic circuit may independently implement neurons in the layer, or may implement multiple neurons in the layer. Similarly, the circuits that calculate neurons may be used only for the calculation of a certain layer, or may be used for the calculation of a plurality of layers.

When all or part of the neural network device 10 is mounted on an ASIC, the ASIC is not limited to a specific one. For example, all or part of the neural network device 10 may be mounted on an ASIC that does not have a CPU. Further, the storage device used for mounting of the neural network device 10 may be arranged in a distributed manner on the chip.

It should be noted that by recording a program for realizing all or some of the functions of the neural network system 1 in a computer-readable recording medium, loading the program recorded in the recording medium into the computer system and executing the program, various processes may be performed. Note that the “computer system” referred to here includes an OS (Operating System) and hardware such as peripheral devices.

Further, the “computer-readable recording medium” is a portable medium such as a flexible disk, a magneto-optical disk, a ROM, or a CD-ROM, or a storage device such as a hard disk built in a computer system. Further, the above-mentioned program may be a program for realizing some of the above-mentioned functions, or may be a program for realizing the above-mentioned functions in combination with a program already recorded in the computer system.

Although the example embodiments of the present invention have been described in detail with reference to the drawings, a specific configuration is not limited to the example embodiments, with designs and the like within a range not deviating from the gist of the present invention also being included.

This application is based upon and claims the benefit of priority from Japanese patent application No. 2019-052880, filed Mar. 20, 2019, the disclosure of which is incorporated herein in its entirety by reference.

### INDUSTRIAL APPLICABILITY

The present invention may be applied to a neural network device, a neural network system, a processing method and a recording medium.

### REFERENCE SYMBOLS

1: Neural network system
10, 100: Neural network device
11, 121: Neuron model unit (neuron model means)
12, 122: Transmission processing unit (transmission processing means)
111: First layer
112: Second layer
113: Third layer
114: Fourth layer
200: Prediction error calculation unit
300: Learning processing unit (learning processing means)

1. A neural network device comprising:
a neuron model means configured as a non-leaky integrate-and-fire spiking neuron and a spiking neuron with which a postsynaptic current is represented using a step function, the neuron model means being fired once at most in one process of a neural network to indicate an output of the neural model means itself at firing timing; and
a transfer processing means for transferring information between the neuron model means.

2. A neural network system comprising:
the neural network device according to claim 1; and
a learning processing means for causing at least one of an output layer and a hidden layer of the neural network device to be learned using a learning rule that applies at least either one of an approximation of differential by weight of firing time and an approximation of differential by firing time of firing time, obtained using a linear approximation of temporal development of membrane potential.

3. The neural network system according to claim 2, wherein the learning processing means causes the output layer of the neural network device to be learned by using a learning rule expressed using a slope of the firing probability density.

4. A processing method comprising:
performing an action of a spiking neuron, the spiking neuron being a non-leaky integrate-and-fire spiking neuron and a spiking neuron with which a postsynaptic current is represented using a step function, the spiking neuron being fired once at most in one process of a neural network to indicate output of the spiking neuron itself at firing timing; and
performing information transfer between the spiking neuron.

5. A non-transitory recording medium that stores a program for causing an application specific integrated circuit (ASIC) to execute:
performing an action of a spiking neuron, the spiking neuron being a non-leaky integrate-and-fire spiking neuron and a spiking neuron with which a postsynaptic current is represented using a step function, the spiking neuron being fired once at most in one process of a neural network to indicate output of the spiking neuron itself at firing timing; and
performing information transfer between the spiking neuron.
